(19) United States
(12) Patent Application Publication
(10) Pub. No.: US 2009/0160980 A1
(43) Pub. Date: Jun. 25, 2009

(54) GRADUATED-BASED DIGITAL IMAGE PROCESSING METHOD

(75) Inventors: Yu-Chen Huang, Jhudong Township (TW); Yin-Pin Chang, Taipei City (TW)

Correspondence Address: STEVENS & SHOWALTER LLP, 7019 CORPORATE WAY, DAYTON, OH, 45459-4238, US

(73) Assignee: ALTEK CORPORATION, Hsinchu (TW)

(21) Appl. No.: 12/139,526

(22) Filed: Jun. 16, 2008

(30) Foreign Application Priority Data
Dec. 19, 2007 (TW) 096148766

(51) Int. Cl. H04N 5/235

(52) U.S. Cl. 348/251

(57) ABSTRACT

A graduated processing method of digital image is adapted to a digital camera for immediately adjusting brightness in different regions of a shot digital image. The processing method includes the following steps. An image capturing device determines an image boundary of a digital image according to an image difference condition in the digital image. Then, a graduated layer is used in the digital image along a vertical direction of the image boundary, and a brightness difference in different regions of the digital image is adjusted.

### CROSS-REFERENCE TO RELATED APPLICATIONS

This non-provisional application claims priority under 35 U.S.C. §119(a) on Patent Application No(s). 096148766 filed in Taiwan, R.O.C. on Dec. 19, 2007, the entire contents of which are hereby incorporated by reference.

### BACKGROUND OF THE INVENTION

1. Field of Invention

The present invention relates to a digital image processing method, and more particularly to an automatic graduated processing method of digital image.

2. Related Art

With a digital camera's rapid development, more and more people joined the photography field. But digital cameras in the shooting, because the metering mechanism will affect digital images of the result will be displayed. If the digital image brightness is over, shooting from digital images easily lead to a normal brightness of the main object, but it is a white background. So many users will send photographs to personal computers, to make use of relevant software for the post-processing system.

However, the post-processing procedure, e.g., contrast adjustment or color curve modification is difficult to operate for a novice. In order to simplify adjustment problems of the digital images, the use of software in many ways to deal with layers of digital images in the different regions of the show. Referring to FIG. 1, a schematic view of a digital image using a graduated layer is shown. For example, in FIG. 1, a partial block is selected from the digital image 100 to serve as the layer to be processed, and an appearance of the layer is determined according to the range to be processed by the user. For example, the layer may be a rectangular, square, round, or irregular region. If a graduated-based processing is required to be performed on the color in the layer, a first color and a second color are selected from the layer. Designated color gradually in the direction of change, graduated layer 110 gradually under the first layer of color, and the second color graduated direction from the corresponding graduated layer. Finally, the generated graduated layer 110 is used in the selected region of the digital image 110, such that the digital image 100 is much closer to the original appearance of the shot scene.

However, the processing must be executed on personal computer to perform the post process of the digital image 100, and cannot be performed immediately while shooting. Thus, when the user performs the processing on the digital image 100, the user may forget the scene after shooting for a long time.

### SUMMARY OF THE INVENTION

Accordingly, the present invention is directed to provide a graduated-based digital image processing method, adapted to the digital camera for adjusting brightness in the regions of the digital image.

In order to achieve the above objective, the present invention provides a graduated processing method of digital image, which includes the following steps. An image capturing device determines an image boundary of a digital image according to an image difference condition in the digital image. A graduated layer is used in the digital image along a vertical direction of the image boundary, and a brightness difference in different regions in the digital image is adjusted.

In the present invention, the corresponding image boundary is generated according to the image difference condition in the digital image. The graduated-based digital image processing is performed according to the image boundary, so as to adjust brightness in different regions of the digital image. Thus, the digital image is much closer to the actual status of the shot scene.

### BRIEF DESCRIPTION OF THE DRAWINGS

The present invention will become more fully understood from the detailed description given herein below for illustration only, and thus are not limitative of the present invention, and wherein:

FIG. 1 is a schematic view of the digital image using the graduated layer;

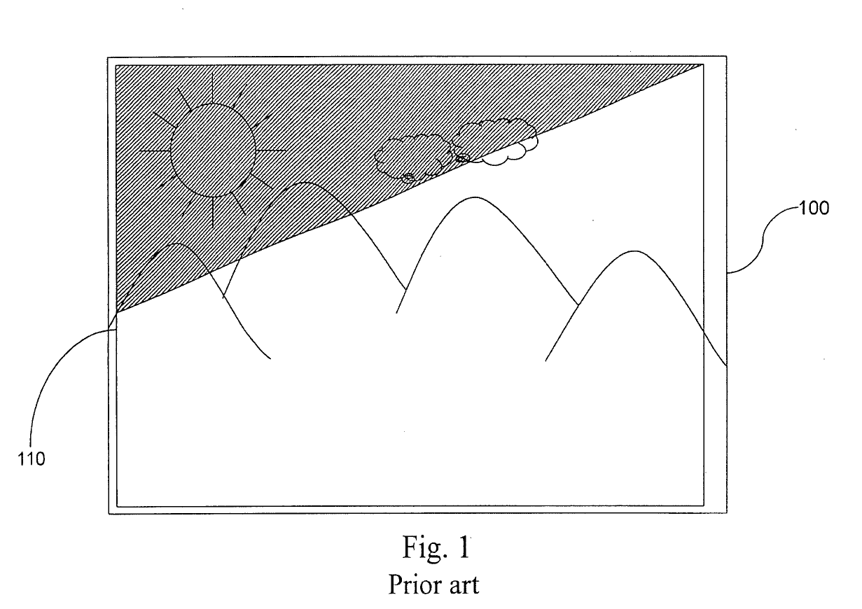

FIG. 2 is a schematic view of the operation flow of the present invention;

FIG. 3a is a schematic view of the image boundary and the graduated direction;

FIG. 3b is a schematic view of the digital image using the graduated layer;

FIG. 4a is a schematic view of the implementation of the graduated layer according to another preferred embodiment; and

FIG. 4b is a schematic view of the implementation of the graduated layer according to another preferred embodiment.

### DETAILED DESCRIPTION OF THE INVENTION

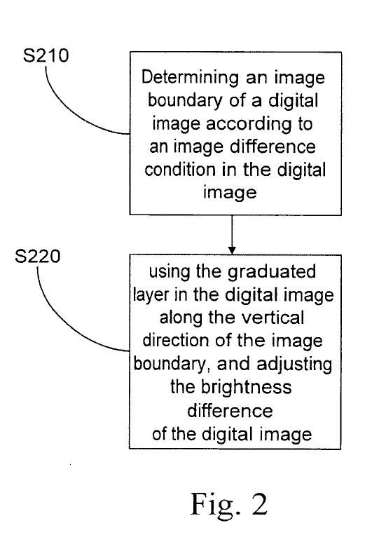

The present invention is applicable to brightness adjustment in different regions of the digital image, such that the status of the frame of the digital image is much closer to the shot scene. Referring to FIG. 2, a schematic view of the operation flow of the present invention is shown. The graduated processing method of digital image of the present invention includes the following steps. An image capturing device determines an image boundary of a digital image according to an image difference condition in the digital image (step S210). The image difference condition is determined according to the color difference, the brightness, or the contrast of the digital image.

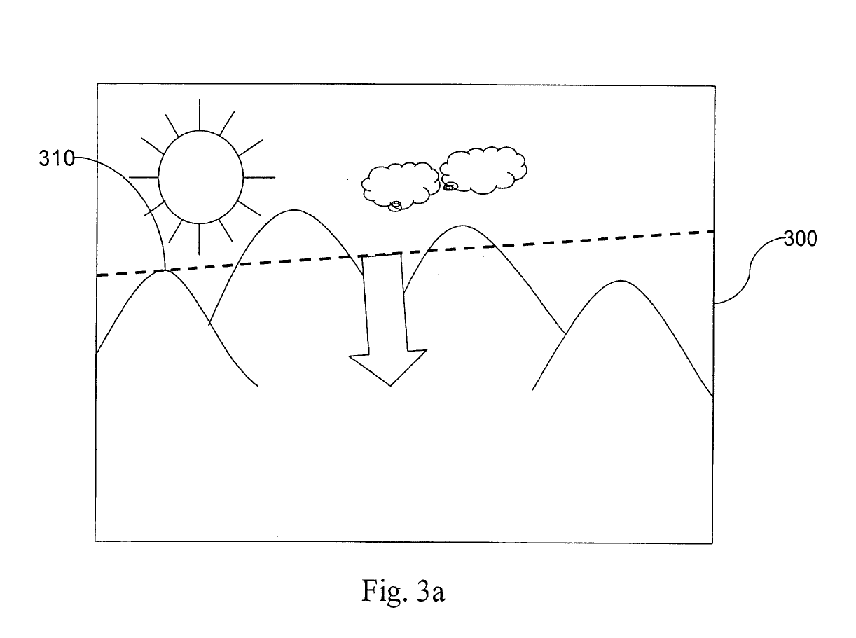

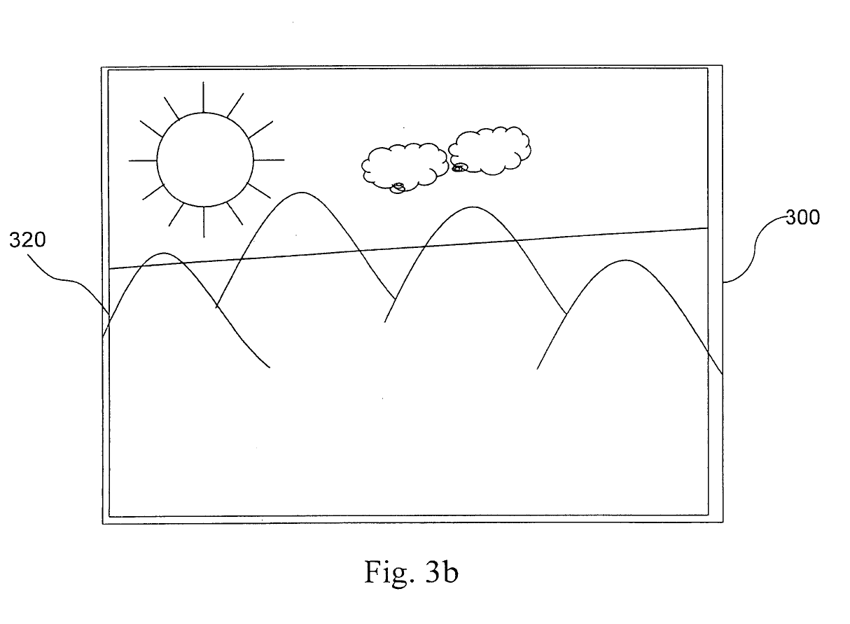

A graduated layer is used in the digital image along a vertical direction of the image boundary, and a brightness of the specified region of the layer in the digital image is adjusted (step S220). The graduated manner is used to reduce the trace of the post process so as to naturally present the modified result. In the present invention, the graduated layer is used to perform the graduated processing on the brightness in different regions. In addition, referring to FIGS. 3a and 3b, a schematic view of the image boundary and the graduated direction and a schematic view of the digital image using the graduated layer are shown. A dashed line in FIG. 3a is the image boundary 310 determined in step S210.

The intensity variation in FIG. 3b indicates the graduated direction of the brightness of the graduated layer 320. The graduated layer 320 may be a rectangular, square, round, or irregular region. After the position of the graduated layer 320 on the digital image 300 is determined, and the graduated-based processing is performed on the digital image 300 according to the graduated direction obtained in step S220.

The graduated-based processing method according to the present invention can be applied in the following embodiments.

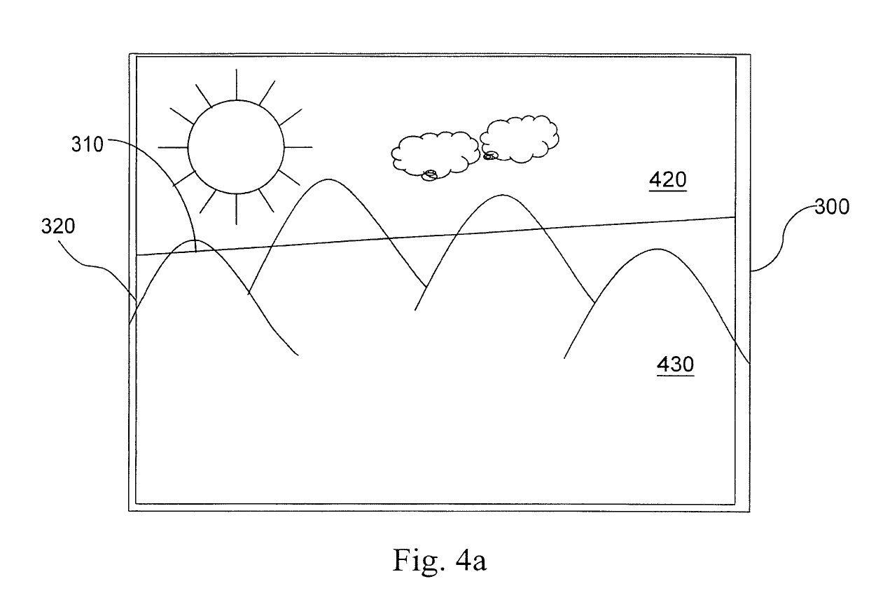

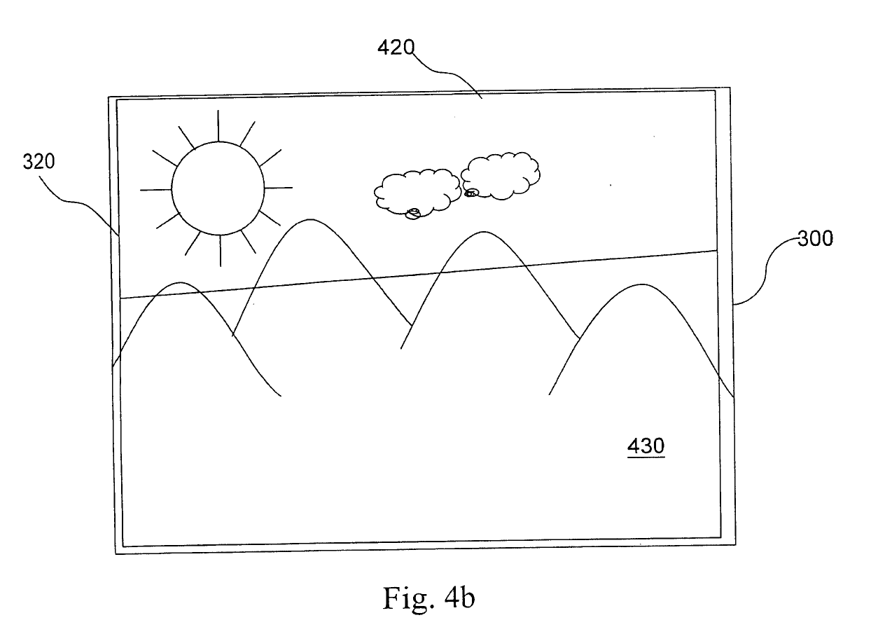

In the embodiment, graduated range size and ratio of the graduated layer 320 are determined according to an area ratio and image information of the first image block 420 and the second image block 430. Referring to FIGS. 4a and 4b, schematic views of the graduated layer according to another preferred embodiment are shown.

Firstly, the digital image 300 is divided into the first image block 420 and the second image block 430 by the image boundary 310 obtained in step S210. Next, a first image information is selected from the first image region, and a second image information is selected from the second image region. The first image information and the second image information may be color, brightness, or contrast. The graduated direction may be from the first image block 420 to the second image block 430 or from the second image block 430 to the first image block 420 according to different processing status. The graduated ratio can also be determined according to different processing status.

If the area of the first image block 420 is larger than the second image block 430, the graduated range in the first image block 420 is larger than that of the second image block 430. In this manner, the digital image 300 is visually smoother after the graduated processing.

In the present invention, the corresponding image boundary 310 is generated according to the image difference condition in the digital image 300. The graduated-based processing is performed on the digital image 300 according to the image boundary 310, thereby adjusting brightness in different regions of the digital image 300, such that the digital image 300 is more closer to the actual status of the shot scene.

What is claimed is:

1. A graduated processing method of digital image, adapted to a digital camera for adjusting brightness difference of a digital image, comprising:
determining an image boundary of a digital image according to an image difference condition in the digital image; and
using a graduated layer in the digital image along a vertical direction of the image boundary, and adjusting a brightness difference of the digital image.

2. The graduated processing method of digital image as claimed in claim 1, wherein the image difference condition is determined by a brightness of the digital image.

3. The graduated processing method of digital image as claimed in claim 1, wherein the image difference condition is determined by a contrast of the digital image.

4. The graduated processing method of digital image as claimed in claim 1, after determining the image boundary, further comprising at least dividing the digital image to a first image block and a second image block by the image boundary.

5. The graduated processing method of digital image as claimed in claim 4, after using the graduated layer, further comprising:
determining graduated region ranges of the graduated layer in the first image block and the second image block according to an area ratio of the first image block and the second image block; and
selecting a first image information from the first image region, and selecting a second image information from the second image region, for determining a graduated ratio of the graduated layer.

6. The graduated processing method of digital image as claimed in claim 5, wherein the first image information and the second image information are contrast information, a graduated direction of the graduated layer is from the first image information to the second image information, and the ratio is determined by a relation between the first image information and the second image information.

7. The graduated processing method of digital image as claimed in claim 5, wherein the first image information and the second image information are contrast information, a graduated direction of the graduated layer is from the second image information to the first image information, and the ratio is determined by a relation between the first image information and the second image information.

8. The graduated processing method of digital image as claimed in claim 5, wherein the first image information and the second image information are brightness information, a graduated direction of the graduated layer is from the first image information to the second image information, and the ratio is determined by a relation between the first image information and the second image information.

9. The graduated processing method of digital image as claimed in claim 5, wherein the first image information and the second image information are brightness information, a graduated direction of the graduated layer is from the second image information to the first image information, and the ratio is determined by a relation between the first image information and the second image information.
